(19) United States
(12) Patent Application Publication
(10) Pub. No.: US 2024/0252903 A1
(43) Pub. Date: Aug. 1, 2024

(54) STANCE ALIGNMENT DEVICE

(71) Applicant: Christoffel Johannes Henze DE WET, Bloemfontein (ZA)

(72) Inventor: Christoffel Johannes Henze DE WET, Bloemfontein (ZA)

(21) Appl. No.: 18/565,794

(22) PCT Filed: May 27, 2022
(86) PCT No.: PCT/IB2022/055007

§ 371 Date: Nov. 30, 2023

(30) Foreign Application Priority Data
May 31, 2021 (ZA) 2021/03697

(51) Int. Cl. A63B 69/36

(52) U.S. Cl. CPC A63B 69/3667; A63B 2220/12; A63B 2220/83; A63B 2225/50

(57) ABSTRACT

This invention relates to a stance alignment device (1) more particularly a stance alignment device for use while playing a shot in golf. The stance alignment device makes use of a projector (2) inside a housing (3) which projects a grid (4) onto a surface. In this embodiment the grid is projected by means of lasers. The grid is used to assist a golf player (13) in practicing to align their feet (6) and club (7) in relation to a ball (5) and in the direction of a target, such as a hole (8) or fairway. The projector (2) is connected to a tripod (9) with extendable legs in order to provide a higher angle of projection. Machine learning is used to ensure that the grid is changed according to a player's needs.

### FIELD OF THE INVENTION

This invention relates to a stance alignment device more particularly a stance alignment device for use while playing a shot in golf.

### BACKGROUND TO THE INVENTION

U.S. Pat. No. 7,112,145B2 entitled “Golf training device” in the name of Mark Gaddy describes a golf training device that assists a golfer in sighting the direction to hit, and in the proper alignment of his body with respect to the golf ball. The device has a housing for mounting at least two lasers having a vertical element that provides vertical support for the lasers, a base element that enables at least a portion of the housing to be oriented to a desired sighting, and a spike for stabilizing the housing. Each of the lasers has a diffraction optical element that converts a laser beam into a planar arc of light which when projected onto a surface, such as the ground, produces a laser line. The diffraction optical elements are oriented orthogonal to each other and the resulting lines produced by the lasers are orthogonal. One of the laser lines provides feet alignment and the other provides a feet to ball laser reference line.

U.S. Pat. No. 7,727,079B1 entitled “Laser golf alignment device and method” in the name of John A. Kuhlman, Jr. describes a portable, expandable laser golf training device that can be placed on the ground to provide alignment. The present invention can supply a plurality of light beams produced by lasers or other light sources, switchable on and off, that can be projected along the ground both in the direction of play and perpendicular to it. In a folded configuration, the device can project in four directions creating a pair of axis lines running at right angles to each other. In an expanded configuration, one of the major axis lines can be separated into two parallel lines for putting alignment by sliding the halves of the device apart. The device can be used by placing it on the ground in front of the golfer (between the golfer's feet and the ball. Two lines project outward perpendicular to the direction of play, and two or four lines project into and away from the direction of play. These lines provide alignment for the golfer. Various combinations of beams on or off can be selected by a selector switch under control of the user. The device can contain a rechargeable battery.

This could be quite problematic as both these devices project single lines onto a playing surface from a central point, and assume that the playing surface is substantially flat.

Companies such as Garmin and Flightscope have devices which track objects such as golf balls. U.S. Pat. No. 11,016,188B2 entitled “Systems to track a moving sports object” in the name of Henri Johnson describes systems, methods and computer-readable media are provided for tracking a moving sports object. In one example, a method of tracking a moving sports object includes calibrating a perspective of an image of a camera to a perspective of a Doppler radar for simultaneous tracking of the moving sports object, and tracking the moving sports object simultaneously with the camera and Doppler radar. The method may further comprise removing offsets or minimizing differences between simultaneous camera measurements and Doppler radar measurements of the moving sports object. The method may also include combining a camera measurement of an angular position of the moving sports object with a simultaneous Doppler measurement of a radial distance, speed or other measurement of the moving sports object.

These devices merely track the ball's movement but does not provide a suggested stance to improve a player's skill.

### OBJECT OF THE INVENTION

It is an object of this invention to provide a stance alignment device which, at least partially, alleviates some of the above-mentioned difficulties.

### SUMMARY OF THE INVENTION

In accordance with this invention there is provided a stance alignment device comprising a housing for a projector which projects a grid onto a surface, the grid being used to aid in taking aim at a target.

The projector may be a laser projector which converts the laser beam into a network of lines that cross each other to form a series of squares or rectangles.

The housing may be connected to a surface engager such as a peg or a tripod having extendable legs.

The housing may have an elongate shape in order to give length to the grid.

The housing may have a connector which can be used to connect the housing to objects other than a surface engager.

The area of the grid may be enlarged or reduced manually or automatically.

The housing may include a processing unit.

The processing unit may aid in orientating the housing.

The processing unit may incorporate a Global Positioning System (GPS) device.

The processing unit may be connected to an input device.

The input device may be associated with the housing, however any secondary device, remote device or third-party device may be utilised as an input device.

The input device may be used to record data to be read into the processing unit.

Data recorded by the input device can be data relating to the speed, direction or rotation of an object passing by the input device.

Data recorded by the input device may include data relating to objects which are stationary, or which moved from a stationary position.

The processing unit may be connected to an output device.

The processing unit may adjust the grid based on the data collected.

The processing unit may further incorporate a wireless communications module to communicate with a mobile device, the input device or any other appropriate input or output device.

The grid is not limited to only displaying a series or squares or rectangles, and other shapes, such as circles, footprints, arrows, guidelines or the like can be projected onto the surface.

The invention also provides for specific lines to differ in colour from other lines, and specific squares, rectangles or shapes can be filled with a variety of colours.

The grid may be static or may be animated/variable to show movement or data history.

In accordance with this invention there is provided a golf stance alignment device comprising a housing for a projector which projects a grid onto a playing surface, the grid being used to aid in taking aim at a target.

In accordance with this invention there is provided an alignment device comprising a housing for a projector which projects a grid onto a playing surface, the grid being used to aid in taking aim at a target.

These and other features of the invention are described in more detail below.

### BRIEF DESCRIPTION OF THE DRAWINGS

Embodiments of the invention are described below, by way of example only, with reference to the drawings in which:

FIG. 1 shows a stance alignment device in use;

FIG. 2 shows a perspective view of the device of FIG. 1;

FIG. 3 shows a perspective view of the device of FIG. 1 on an uneven surface;

FIG. 4 shows a perspective view of an alternative embodiment of the device;

FIG. 5 shows a plan view of the device;

FIG. 6 shows a stance alignment device in an alternative use;

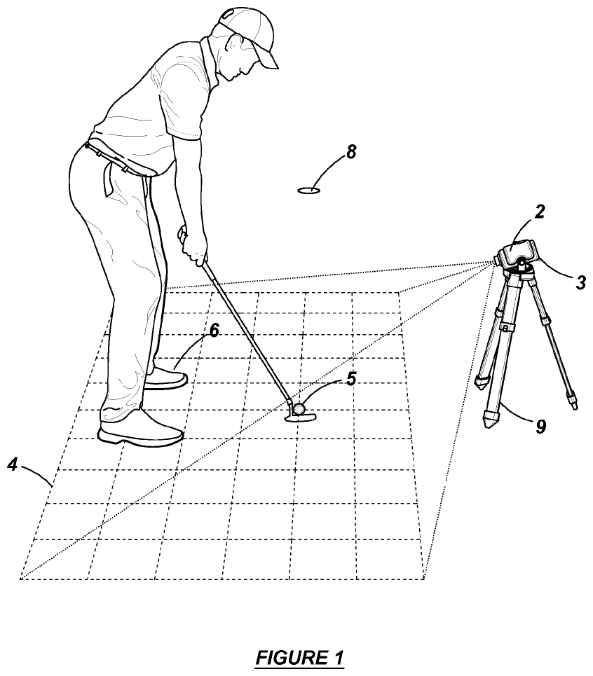

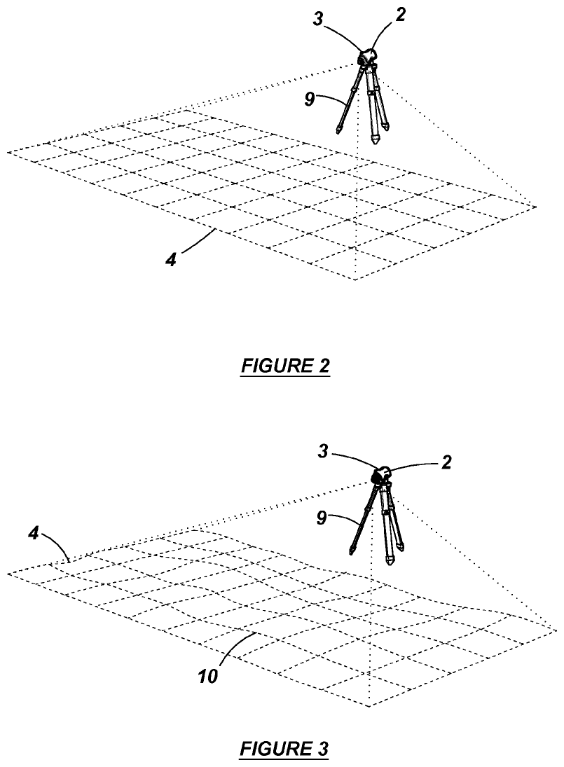

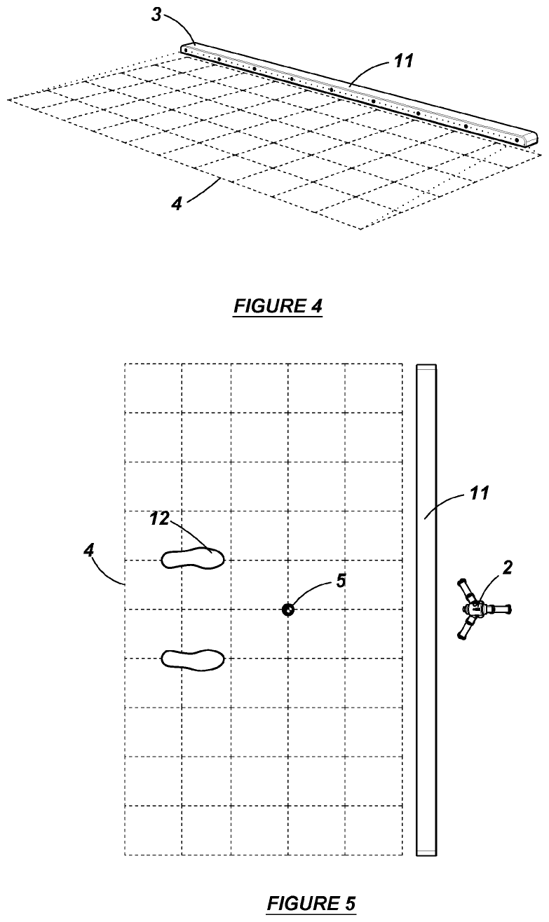

### DETAILED DESCRIPTION OF THE DRAWINGS

With reference to the drawings, a stance alignment device is generally depicted by reference numeral 1.

A stance alignment device 1 makes use of a projector 2 inside a housing 3 which projects a grid 4 onto a surface. In this embodiment the grid 4 is projected by means of lasers.

The grid 4 is used to assist a golf player 13 in practicing to align their feet 6 and club 7 in relation to a ball 5 and in the direction of a target, such as a hole 8 or fairway.

The projector 2 is connected to a tripod 9 with extendable legs in order to provide a higher angle of projection however any leg or peg which provides a higher angle of projection can be used. This higher angle of projection reduces shadows or blind spots in the grid 4 whilst still pointing out any irregular changes 10 in the surface.

The area of the grid 4 can be enlarged or reduced as required. Specific lines or rectangles can be changed in colour or shape in order to further assist and ensure that the player 13 aligns their feet 6 and club 7 correctly in relation to the ball 5. This can all be done manually, by the player 13, or automatically by a processing unit (not shown) in the housing 3.

The processing unit makes use of a GPS to locate itself and automatically align the housing 3 in accordance with the hole 8. Course layouts are stored either on the device 1 or can be downloaded from the internet or any other server to the device or an input device. The device 1 will then always be able to ascertain where it finds itself in relation to the hole 8 which is currently being played.

The processing unit includes a wireless transceiver which allows the player 13 to manually override the automatic alignment by means of a mobile device, such as a smartphone, tablet or smartwatch. Golf courses are laid out with great care to ensure that there is still a level of skill involved. It may be that the hole 8 is not in line of sight of the player 13. The player 13 may wish to aim at a different part of the course such as the fairway or a specific landmark, target, tree or line and will then manually override the stance alignment device 1 to assist in taking aim at a target other than the hole 8.

Specific lines in the grid 4 differ in colour to aid in a variety of alignments. The grid 4 is not limited to displaying squares or rectangles, and may be configured to allow for footprint shapes, ball shapes or a guide of the line which the club needs to follow to be shown. The footprint shapes will ensure that the player's 13 feet 6 are in the correct position. A ball shape will ensure that the ball 5 is placed in an appropriate spot in relation to the stance/foot placement of the player 13. The club used may be selected to further aid in determining the ball 5 placement in relation to the foot 6 placement or stance of the player 13 as well as the swing line the club should follow. Guidelines will ensure that the player 13 maintains a correct backswing and follow-through. Animation showing club speed may be provided to ensure that a player 13 maintains a consistent swing.

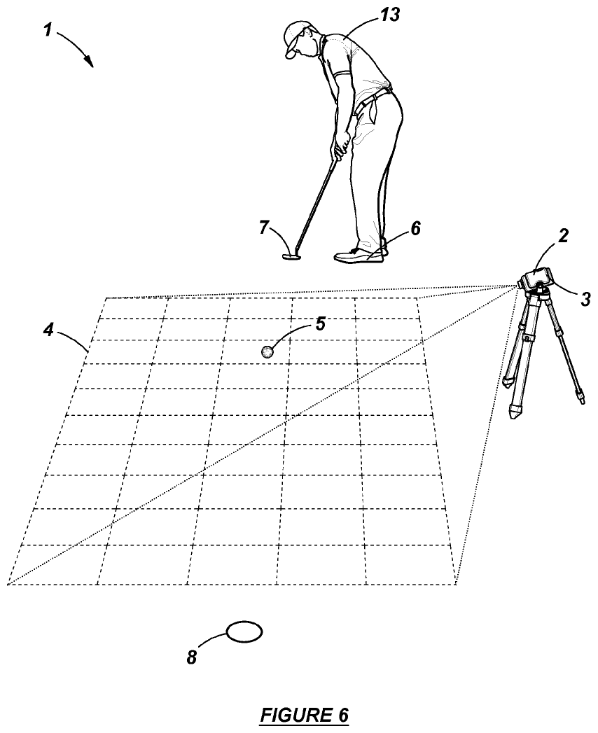

The grid 4 does not need to be used to align a player's 13 feet 6 and club 7, FIG. 6 shows how the projector 2 can be used to project a grid 4 on a different part of the surface, such as a green to show contours or irregularities in the surface. This will help players to imagine a ‘line’/apex to aim at in order for the ball 5 to end up in or as close to the hole 8 as possible.

In a further embodiment, the housing may have an elongate shape 11 in order to give length to the grid and still fit inside a golf bag amongst the clubs. Club bags or golf carts may also be configured to have a stance alignment device incorporated into the body of the bag and/or cart.

The housing may also include a device for sensing movement such as the speed and direction of the golf club or the speed, direction rotation or launch angle and/or flight of the golf ball. The device may also capture the position of stationary objects such as feet, the ball 5 or pin height or capture the movement of any object from a stationary position such as the golf ball 5 after being struck by the golf club 7. Data captured by the sensor may be relayed to the processing unit or transmitted to the external mobile device. This data may be referred to in future and be associated with the player.

The processing unit may be connected to any input or output device. External devices, remote devices or third-party ball tracking devices may be used to track the movement, trajectory, or end location of the golf ball. The processing unit will then use the input data to adjust the grid in order for the ball to be in a more favourable starting placement in relation to the player's stance to ensure that a following, similar, shot played will end up in a more favourable end location in relation to the ultimate target. Specific ball placement and lines indicating club swing direction for shots such as a “draw”, “fade”, “chip” or “stinger” etc may be provided by the grid.

The stance alignment device will thus continuously “learn” from the player's shot history to assist in improving the players set-up and posture.

The device is not limited to projecting a static or still grid and an animated grid, showing, for instance shot history, or historical ball placement may be used to indicate improvement of the players skill.

The input device may also learn from the player. The input device may be calibrated, at the start of the training, to recognise the player's natural feet or foot placement and the ball placement such as placement in relation to the feet, or height of the ball on the pin. The grid may then be projected in accordance with the player's natural stance. As the alignment device gathers more data and learns from any device such as the input device, ball tracking devices or user input, the device may project small changes to grid to suggest changes to the player's stance. The stance alignment device will then compare the end result after a shot is played with the suggested stance and calculate whether the shot as played with the suggested stance is better or not and adjust itself accordingly for a next shot.

A player may also remember a shot or stance which was favourable and use the manual input to request the grid as it was when the favourable shot was played. The device will then project the requested grid from memory.

There is further provided for the housing to have a connector which can be used to connect the housing to objects other than a surface engager such as the player's golf bag, golf cart, or any other appropriate support.

The device is not limited to be used in the sport of golf and there is provided for an alignment device comprising a housing for a projector which projects a grid onto a playing surface, the grid being used to aid in taking aim at a target. For instance the device may be used atop or above a billiard table to aid in the alignment of a shot or even be projected onto a batting crease for a cricket batsman to practice foot placement. Kickers in football sports such as soccer, rugby or gridiron could make use of similar devices when training to practice their aim.

It is envisaged that the invention as described herein will assist golfers of all levels in practicing their stance.

This should significantly improve players' enjoyment of the game of golf as it will enhance their skill levels.

It will be appreciated by those skilled in the art that the invention is not limited to the precise details as described herein and that other embodiments and uses are available.

1. A stance alignment device comprising a housing for a projector which projects a grid onto a surface, the grid being used to aid in taking aim at a target.

2. The stance alignment device as claimed in claim 1 wherein the projector is a laser projector.

3. The stance alignment device as claimed in any of claim 1 and claim 2 wherein the laser projector converts a laser beam into a network of lines.

4. The stance alignment device as claimed in any of claim 1 to claim 3 wherein the network of lines crosses each other to form a series of rectangles.

5. The stance alignment device as claimed in any of claim 1 to claim 3 wherein the network of lines includes shapes which are not a series of rectangles.

6. The stance alignment device as claimed in any of the preceding claims wherein the housing is connected to a surface engager.

7. The stance alignment device as claimed in any of the preceding claims wherein the surface engager is a peg.

8. The stance alignment device as claimed in any of claim 1 to claim 6 wherein the surface engager is a tripod.

9. The stance alignment device as claimed in any of the preceding claims wherein the housing has an elongate shape.

10. The stance alignment device as claimed in any of the preceding claims wherein the housing has a connector which is used to connect the housing to objects other than a surface engager.

11. The stance alignment device as claimed in any of the preceding claims wherein the area of the grid is automatically scalable.

12. The stance alignment device as claimed in claim 1 to claim 10 wherein the area of the grid is manually scalable.

13. The stance alignment device as claimed in any of the preceding claims wherein the housing includes a processing unit.

14. The stance alignment device as claimed in any of the preceding claims wherein the processing unit aids in orientating the housing.

15. The stance alignment device as claimed in any of the preceding claims wherein the processing unit is connected to a Global Positioning System device.

16. The stance alignment device as claimed in any of the preceding claims wherein the processing unit is connected to an input device.

17. The stance alignment device as claimed in any of the preceding claims wherein the input device is associated with the housing.

18. The stance alignment device as claimed in claim 1 to claim 16 wherein the input device is a secondary device.

19. The stance alignment device as claimed in claim 1 to claim 16 wherein the input device is a remote device.

20. The stance alignment device as claimed in claim 1 to claim 16 wherein the input device is a third-party device.

21. The stance alignment device as claimed in any of the preceding claims wherein the input device is used to record data to be read into the processing unit.

22. The stance alignment device as claimed in any of the preceding claims wherein the processing unit automatically adjusts the grid based on the data collected.

23. The stance alignment device as claimed in any of the preceding claims wherein the processing unit adjusts the grid based on the user input.

24. The stance alignment device as claimed in any of the preceding claims wherein the data recorded by the input device can be data relating to the speed of an object passing by the input device.

25. The stance alignment device as claimed in claim 1 to claim 23 wherein the data recorded by the input device can be data relating to the direction of an object passing by the input device.

26. The stance alignment device as claimed in claim 1 to claim 23 wherein the data recorded by the input device can be data relating to the rotation of an object passing by the input device.

27. The stance alignment device as claimed in any of the preceding claims wherein the data recorded by the input device includes data relating to an object which is in a stationary position.

28. The stance alignment device as claimed in claim 1 to claim 26 wherein the data recorded by the input device includes data relating to an object which moved from a stationary position.

29. The stance alignment device as claimed in any of the preceding claims wherein the processing unit is connected to an output device.

30. The stance alignment device as claimed in any of the preceding claims wherein the processing unit is connected to a wireless communications module.

31. The stance alignment device as claimed in claim 1 to claim 29 wherein the wireless communications module communicates with a mobile device.

32. The stance alignment device as claimed in claim 1 to claim 29 wherein the wireless communications module communicates with the input device.

33. The stance alignment device as claimed in claim 1 to claim 29 wherein the wireless communications module communicates with an output device.

34. The stance alignment device as claimed in any of the preceding claims wherein specific lines differs in colour from other lines.

35. The stance alignment device as claimed in any of the preceding claims wherein specific rectangles differs in colour from other rectangles.

36. The stance alignment device as claimed in any of the preceding claims wherein specific shapes are filled with colours.

37. The stance alignment device as claimed in any of the preceding claims wherein the grid is static.

38. The stance alignment device as claimed in claim 1 to claim 36 wherein the grid is variable.

39. The stance alignment device as claimed in any of the preceding claims wherein machine learning is used to adjust the grid.

40. A golf stance alignment device comprising a housing for a projector which projects a grid onto a playing surface, the grid being used to aid in taking aim at a target.

41. An alignment device comprising a housing for a projector which projects a grid onto a playing surface, the grid being used to aid in taking aim at a target.
